(19) United States
(12) Patent Application Publication
(10) Pub. No.: US 2015/0345812 A1
(43) Pub. Date: Dec. 3, 2015

(54) METHOD AND APPARATUS FOR SELECTIVE COMPONENTIZED THERMOSTATIC CONTROLLABLE LOADS

(71) Applicant: Wireless Glue Networks, Inc., Blackhawk, CA (US)

(72) Inventor: Nathan Murthy, Missouri City, TX (US)

(21) Appl. No.: 14/718,758

(22) Filed: May 21, 2015

Related U.S. Application Data
(60) Provisional application No. 62/003,285, filed on May 27, 2014.

(51) Int. Cl. F24F 11/00; G05B 15/02

(52) U.S. Cl. CPC F24F 11/006; F24F 11/001; F24F 11/0076; F24F 11/0086; G05B 15/02; F24F 11/0012; F24F 2011/0046; F24F 2011/0047; F24F 2011/0057; F24F 2011/0063; F24F 2011/0064; F24F 2011/0075; F24F 2011/0094

(57) ABSTRACT

The present invention is directed towards a system, apparatus and method for controlling thermostatic electric loads (TELs). In one embodiment, the method comprises transmitting, from a demand response server, a demand response event signal to a plurality of energy gateways, the demand response corresponding to an efficiency requirement of a coupled grid, receiving, from the plurality of energy gateways, a load profile for each of a plurality of thermostatic electric loads (TELs) coupled to each of the plurality of energy gateways and transmitting one or more control signals to the energy gateways to control operation of the plurality of TELs to yield an efficiency corresponding to the efficiency requirement.

### CROSS-REFERENCE TO RELATED APPLICATION

This application claims benefit of U.S. Provisional Patent Application Ser. No. 62/003,285, filed May 27, 2014, which is incorporated herein by reference in its entirety.

### BACKGROUND OF THE INVENTION

1. Field

Embodiments of the present disclosure relate generally to control of power consumption, and, in particular, to distributed controllable of thermostatic loads.

2. Description of the Related Art

Remotely controlling thermostatic electric loads (TELs) such as heating, ventilation, and air conditioning (HVAC) units in homes and businesses during peak consumption hours has become a common practice of many electric power utilities. The control allows for issuing a demand response event signal that dynamically adjusts HVAC loads to conserve power and prevent overloading a power grid and ensure power distribution stability for the electric power utilities and consumers.

One method of direct TEL control has been to remotely adjust the temperature set points of the loads to reduce energy consumption. Typically this method is implemented by installing an AM or FM receiver with a relay on a heating unit or a cooling unit. A signal for a demand response event is then broadcast over the AM/FM network and induces the receiver-relay to disconnect the load from the power grid. For example, the heating unit of a building during winter is controlled to allow a measured temperature to drift lower a few degrees. Similarly, for a cooling unit during summer, the temperature is allowed to drift upward a few degrees. The method may also rely on Internet-based communication standards instead of AM/FM broadcast infrastructure. However, TEL control based solely on temperature does not provide maximum efficiency and comfort for building occupants in usage cycles. For example, in a heating unit, the heating coils may retain residual heat after the unit is cycled off. The building occupants (e.g., HVAC users) are thus disadvantageously unable to receive any residual heat in the system. In addition, the system must otherwise cycle on more frequently if the residual heat is not disbursed into the building.

Therefore, there is a need in the art for a system, method, and apparatus that provides efficient control of thermostatic electric loads based on electric consumption for specific temperatures during demand response as well as utilize residual energy.

### SUMMARY OF THE INVENTION

Embodiments of the present invention generally relate to a system, method, and apparatus for controlling thermostatic electric loads (TELs) using selective componentized loads as shown in and/or described in connection with at least one of the figures, as set forth more completely in the claims.

Various advantages, aspects and novel features of the present disclosure, as well as details of an illustrated embodiment thereof, will be more fully understood from the following description and drawings.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a diagram of an exemplary system for generating and using componentized load profiles and demand response control in accordance with an embodiment of the present invention;

FIG. 1B is a block diagram of an exemplary demand response server of the system in FIG. 1A in accordance with an embodiment of the present invention;

FIG. 2 is a diagram of an exemplary componentized thermostatic electric load in accordance with an embodiment of the present invention;

FIG. 3 is block diagram of an exemplary controller in an energy gateway operating the load profile generation and demand response control system depicted in FIG. 1 in accordance with an embodiment of the present invention;

FIG. 4 is a flow diagram of an exemplary method for generating profiles of individual componentized loads in accordance with an embodiment of the present invention;

FIG. 5 is a flow diagram of an exemplary method for demand response using the componentized load profiles in accordance with an embodiment of the present invention; and

FIG. 6 is a flow diagram of an exemplary method for reduced operation of thermostatic electric loads in accordance with an embodiment of the present invention.

### DETAILED DESCRIPTION

By monitoring temperature and energy consumption of individual components in a thermostatic electric load (TEL), load compensation may be more accurately and finely adjusted. In addition, individual TELs can output residual energy from heat exchangers by selectively turning on and off actuators (e.g., fans) in the TEL. Residual heated or cool air is thus distributed into a building that prolongs the duration between cycling a TEL to full power and conserves energy.

Monitoring of TELs using repeated intervals allows for the generation of load profiles for each component of respective TELs based on historic data and preferences for buildings. The load profiles correlate power consumption and desired thermostat temperature for each room, building, or groups of buildings, depending on the desired granularity. The correlation is subsequently used to establish a demand response with complimentary matching component profiles so as to yield compensation that (from the perspective of the grid) has a balanced load trajectory during demand response events with minimized temperature deviation for the user. With a balanced load trajectory, buildings may be operated over a wider range of temperatures or be allowed to operate closer to a desired temperature for a longer duration while conserving energy as required by the utility.

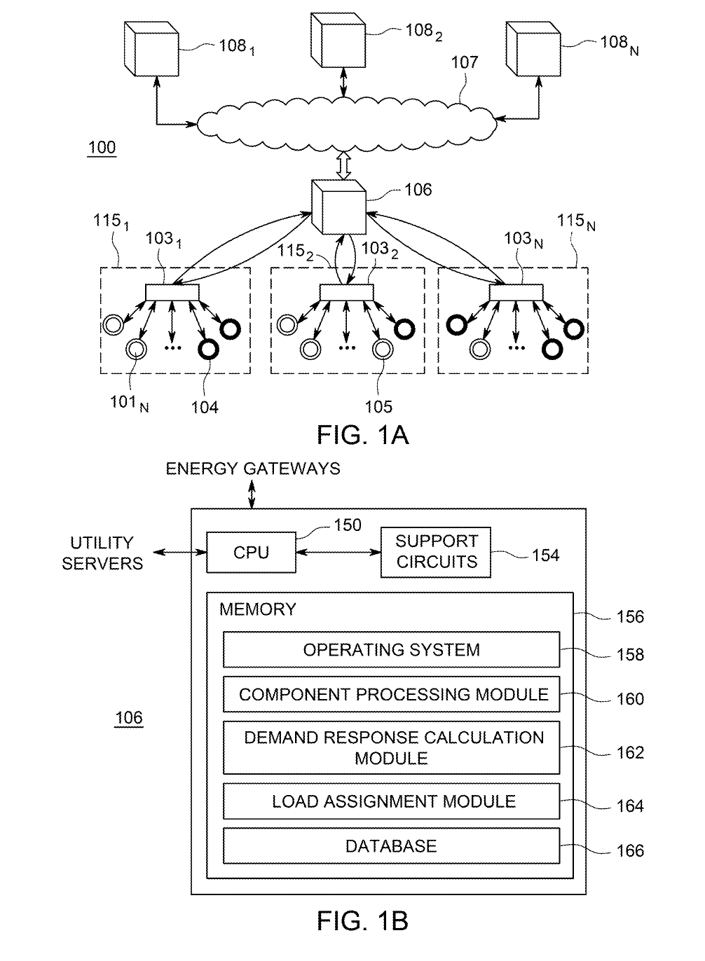

FIG. 1A is a diagram of an exemplary system 100 for generating componentized load profiles and demand response control in accordance with an embodiment of the present invention. The system 100 includes a communications infrastructure in preparation for, and during a demand response (DR) event. The system 100 comprises multiple thermostatic electric loads (TELs) 101_{N}, energy gateways 103_{N}, an automated DR server 106, and a network 107 enabling the DR server 106 to communicate with utility servers 108_{N}. The network 107 may be wired, wireless, a local area network (LAN), a wide area network (WAN), the Internet, or a combination thereof.

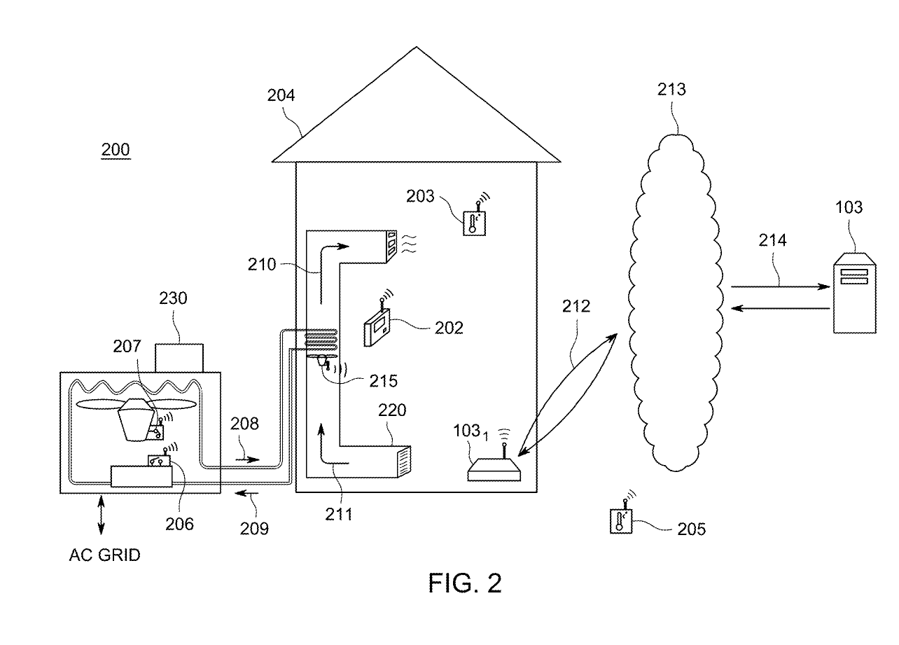

TELs 101_{N} include HVAC systems, heaters, air conditioners, refrigerators, chillers, and the like. TELs 101_{N} can either be in an ON state 104 or an OFF state 105. There may be several TELs 101_{N} on a single premise (e.g., local area 115₁) or, alternatively, tied to a single customer account. In the OFF state, a thermostatic load is not drawing any power. The ON state 104 is composed of an initial transient “cold-load” pick-up, or surge in power consumption, followed by a steady-state power consumption level as the system (e.g., TEL 101₁) settles before TEL 101₁ is turned OFF 105 again. As will be discussed further in FIG. 2, TELs 101_{N} are configured with additional energy consumption sensors, temperature detectors, and electronics to individually control actuators (e.g., components) in each TEL.

Energy gateways 103_{N} collect real-time sensor data from TELs 101_{N} (e.g., temperature, other weather, date, time, power consumed, consumption duration, and the like) and dispatch local control actions from the DR server 106 on the TELs 101_{N}, such that each energy gateway 103_{N} corresponds to a local area 115_{N}. Each local area 115_{N}, may correspond to a room, building, series of buildings, city, and the like for various load granularities. Energy gateways are operative to also communicate and control individual components in each TEL. In other embodiments, the energy gateways 103_{N} can also communicate with non-thermostatic loads.

Communication signals with energy gateways 103_{N} in the system 100 for are passed over wireless protocols such as IEEE 802.11 or 802.15 (ZIGBEE or SMART ENERGY PROFILE) or may be passed over other protocols such as ECHONET, BACNET, or MODBUS. In some embodiments, multiple energy gateways 103_{N} are communicatively coupled as a single resource under the management of the DR server 106 that may communicate over non-proprietary Internet-based protocols such as those outlined under OPENADR. In some embodiments, the energy gateways 103_{N} are logical or virtual entities that operate as a software module either on a virtual machine, base operating system, and existing energy management system, set-top box, or other hardware devices. An analytics engine runs on the gateway for local-area control, or on the server for wide-area control. In other embodiments, energy gateways 103_{N} may include specifically designed software and ASICs.

Energy gateways 103_{N} generate component load profiles for each of the TELs 101_{N} as well as correlate the overall load profiles to a specific demand response received from the DR server 106. Load profiles are generated using historic data over a monitoring period (e.g., one month) that develop a heuristic approach in profile generation. Historic monitoring associates date, time, weather conditions, user preferences and the like to develop load profiles that provide accurate correlations as to what a set TEL 101_{N} temperature is required and how much power is consumed to maintain the temperature. In addition, load profiles may be operated in the aggregate by the energy gateways 103_{N} to yield a balanced load profile. The balanced load profile reduces strain on the grid, and maximizes the power supplied during generation utilities.

DR server 106 securely interfaces with systems that define the load dispatch, billing, aggregation parameters of each of the energy gateways and with supply-side resources for issuing control signals to improve the reliability or economic efficiency of the grid. The DR server 106 may interface with utility servers 108_{N} over the network 107. In some embodiments, utility servers 108_{N} include a price server and an energy trading platform for retail or wholesale electricity markets. In other embodiments, the utility servers 108_{N} allow the DR server 106 to interface with a load aggregation platform within or across service territories (or load aggregation points in the case of deregulated markets). Alternatively, the utility servers 108_{N} may also be billing and account servers of the electricity providers serving the customers who own energy gateways that may interface with the DR server 106. Thus, the DR server 106 securely interfaces with systems that define the load dispatch, billing, and aggregation parameters of each of the energy gateways 103_{N} and with supply-side resources for issuing control signals to TELs 101_{N} to improve the reliability or economic efficiency of a power grid.

FIG. 1B is a block diagram of an exemplary demand response server 106 of the system in FIG. 1A in accordance with an embodiment of the present invention. In some embodiments, the component load profiles of the TELs 101_{N} are generated on the DR server 106. The DR server 106 comprises a central processing unit (CPU) 150, support circuits 154, and memory 156. The CPU 150 may be any commercially available processor, microprocessor, microcontroller, and the like. In other embodiments, the CPU 150 is a microcontroller such as a PIC. The support circuits 154 comprise well known circuits that provide functionality to the CPU 150 such as clock circuits, communications, cache, power supplies, I/O circuits, and the like.

The memory 156 may be any form of digital storage used for storing data and executable software. Such memory includes, but is not limited to, random access memory, read only memory, disk storage, optical storage, and the like. The memory 156 stores computer readable instructions corresponding to: demand response calculation module 162, and load assignment module 164. Additional embodiments may include a component module 160, an operating system 158 and one or more databases 166 stored in memory 156.

In some embodiments, the component processing module 160 on the DR server 106 receives sensor data for storage from energy gateways 103_{N}. As will be further discussed below, alternative embodiments include generation of component load profiles on the energy gateways 103_{N}. The component processing module 160 includes instructions to process data from TELs (e.g., TELs 101_{N}) and sensors within the TELs. Sensor data may include indoor and outdoor ambient temperatures of a building and/or room, the thermostat temperature setting, and the amount of power consumed when each component of a TEL 101₁ is in an ON state 104 for a pre-determined period (e.g., less than a minute) and correlated with a resultant indoor temperature. The power consumption data is sampled at the steady-state power consumption level for each component. Additional embodiments may include sampling of the initial transient “cold-load” power surge when first turning on each component of a TEL 101. Other embodiments include associating individual component operations with the overall operation of a specific TEL. In such embodiments, individual TELs may be classified as operating in specific full or partial operation modes (a fan only mode, chiller mode, and the like) with a corresponding target temperature and power consumption profile associated with the target temperature. A full operation mode consuming more energy than a partial operation mode.

The component processing module 160 may also aggregate global public background information such as date, time, weather, and the like to correlate with the power consumption level and thermostat temperature with each component. Public background information may be retrieved through the Internet. Other embodiments include generating component load profiles for monitoring and recording energy consumption for operation between specific temperature ranges.

In some embodiments, the component processing module 160 includes adjusting measurements with respect to specific user preferences. For example, a user may prefer a building in the winter to be between 68 and 72 degrees Fahrenheit. To maintain the minimum, a heat exchanger may operate a blower or fan until the temperature falls below 68 degrees, at which point separately controlled heating coils are energized to further raise the temperature. Generated component load profiles based on thermostat temperature settings, actual measured temperatures, and aforementioned background data are stored in database 166.

In other embodiments, the sensor computation module 310 receives actual temperature sensor data directly from temperature sensors placed in the vicinity of a TEL 101₁ vent. In such an embodiment, the component processing module 160 determines how effective cycling various components in a TEL 101₁ results in a given temperature range is to reach a desired temperature. The component processing module 160 also includes background data such as weather (e.g., cooler days may only require fan operation) or day of the week (e.g., weekends at stores may have greater foot traffic and constant air conditioning to a set temperature). For example, cooler days may operate to open a vent to draw in cold outdoor air to cool a building as opposed to energizing a chiller.

The demand response calculation module 162 includes instructions for processing a demand response event and calculating a corresponding response for each component and a corresponding load trajectory. The demand response calculation module 162 is communicatively coupled to the component processing module 160 and load assignment module 164. The demand response calculation module 162 retrieves load profiles stored in the database 166. In other embodiments, the demand response calculation module 162 requests the load profile of a TEL 101 to be instantaneously read. Subsequently, the demand response calculation module 162 determines the optimal temperature setting for TELs 101_{N} to achieve a target power demand as received from the DR server 106. The demand response calculation module 162 then instructs the energy gateways 103_{N} to adjust specific TELs 101_{N} to respective specific temperatures. For example, if a request is received to reduce loads to 1.00 kilowatt (kW) in a certain region or building, the demand response calculation module 162 may control one building to cycle on in a full operation mode around 74 degrees Fahrenheit and another building to 79 degrees Fahrenheit with a fan only mode. The aggregate of the two specifically controlled buildings and components results in an overall balanced load reduction that would otherwise require other neighboring buildings also to raise temperatures to compensate for a demand response event.

In other embodiments, the demand response calculation module 162 may include receiving real-time energy consumption data and indoor temperature data in addition to historical data. The real-time data is applied to adjust in the system 100, specific TELs 101_{N} and corresponding components to model a response of all coupled components in the TELs 101_{N} to meet the demand requirements received from the utility servers 108_{N} or utility provider.

The load assignment module 164 includes instructions for communicating with the energy gateways 103_{N}. Alternatively, the load assignment module 164 includes instructions for communicating with the components of the TELs 101_{N}. The load assignment module 164 converts desired operating temperature signals from the demand response calculation module 162 into the requisite communication signals necessary to control a specific TEL 101₁. For example, the energy gateway 103₁ may be coupled to one TEL 101₁ configured to receive commands wirelessly through IEEE 802.11(g) as well as another TEL 101₂ configured to receive commands through a wired LAN connection or power line communication (PLC).

The load assignment module 164 also coordinates with the demand response calculation module 162 to determine which components of each of the TELs 101_{N} are to be adjusted to meet the calculated necessary load trajectory based on pre-determined profiles. For example, the load assignment module 164 may determine two buildings in one city are able to cycle at a much higher temperature because a load profile determined the TELs 101_{N} of the two have more efficient chillers and fan capabilities than surrounding buildings. As a result, the two buildings can cycle near a higher temperature using fans only to reduce overall grid power demand such that multiple surrounding buildings may operate closer to a desired lower temperature.

FIG. 2 is a diagram of an exemplary componentized thermostatic electric load 200 in accordance with an embodiment of the present invention. The thermostatic electric load (TEL) 200 is operated for a building structure 204 and comprises: an exemplary gateway 103₁, a thermostat device 202, indoor temperature sensors 203, outdoor temperature sensors 205, evaporator fan 215, compressor 206, condenser fan 207, ventilation system 220, and power consumption meter 230. In the depicted embodiment, communication systems are wireless but alternatively may follow wired communication protocols and structures.

The energy gateway 103₁ communicates with the thermostat device 202, and indoor or outdoor temperature sensors 203 and 205 to monitor or control temperature set points. In addition to modulating temperature set points, the energy gateway 103₁ can monitor and control sensor actuators across all primary electromechanical components of the HVAC system. The gateway 103₁ controls components comprising access actuators controlling evaporator fans 215, compressors 206, and condenser fans 207.

In one exemplary operation for the TEL 200, warm refrigerant 209 flows into the compressor 206 and cool refrigerant 208 exits the evaporation coil into the building structure 204. The ventilation system 220 intakes warm air 211 and returns cold air 210. Each of these components can be controlled and/or monitored by the energy gateway 103₁ to optimize the comfort of the occupants inside the residential or commercial space all while reducing energy use and maintaining a reliable connection to the grid 226. The energy gateway has access to the Internet 213 and has bi-directional access 214 to DR server 106 and other servers 108_{N} described in the system architecture above.

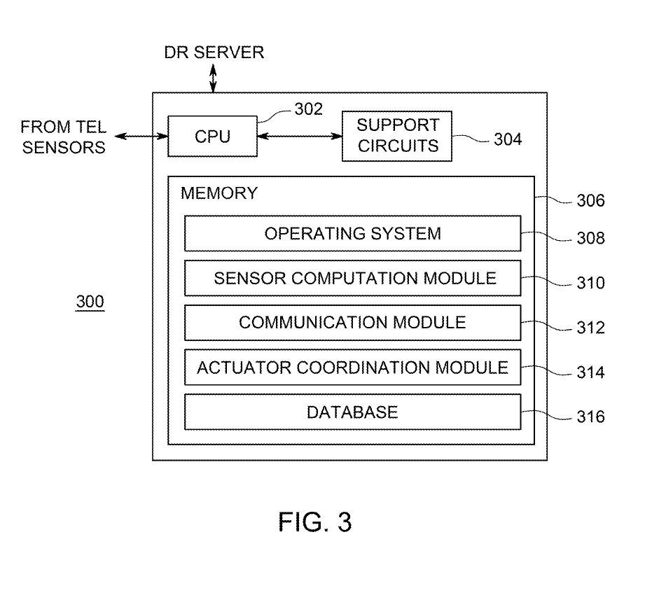

FIG. 3 is block diagram of an exemplary controller 300 in an energy gateway 103_{N} operating the load profile generation and demand response control system depicted above in FIG. 1 in accordance with an embodiment of the present invention. In some embodiments, the component load profiles of the TELs 101_{N} are generated on the energy gateways 103_{N}.

The controller 300 comprises a central processing unit (CPU) 302, support circuits 304, and memory 308. The CPU 302 may be any commercially available processor, microprocessor, microcontroller, and the like. In other embodiments, the CPU 302 is a microcontroller such as a PIC. The support circuits 304 comprise well known circuits that provide functionality to the CPU 302 such as clock circuits, communications, cache, power supplies, I/O circuits, and the like.

The memory 306 may be any form of digital storage used for storing data and executable software. Such memory includes, but is not limited to, random access memory, read only memory, disk storage, optical storage, and the like. The memory 306 stores computer readable instructions corresponding to: a sensor computation module 310, communication module 312, and actuator coordination module 314. Additional embodiments may include an operating system 308 and one or more databases 316 stored in memory 306.

The sensor computation module 310 includes instructions to process data from sensors and detectors distributed in or in the proximity of each of the TELs (e.g., TELs 101_{N}). Sensor data may include indoor and outdoor ambient temperatures of a building and/or room, the thermostat temperature setting, and the amount of power consumed when a TEL 101₁ is in an ON state 104 for a pre-determined period (e.g., less than a minute). The power consumption data is sampled at the stead-state power consumption level. Additional embodiments may include sampling of the initial transient “cold-load” power surge when first turning on a TEL 101. The load profile generation module 311 aggregates global public background information such as date, time, weather, and the like to correlate with the power consumption level and thermostat temperature. Other embodiments include generating load profiles for monitoring and recording energy consumption for operation between specific temperature ranges. In some embodiments, the sensor computation module 310 includes specific user preferences.

In other embodiments, energy gateways 103_{N} may upload component load profiles and system measurements to the DR server 106 to conserve memory resources. Alternatively, the component load profiles and system measurements may be uploaded to a component processing module 160 on the DR server 106. In such an embodiment, the component processing module 160, organizes the measurements for coordination of a load trajectory communicated to the communication module 312.

In other embodiments, the sensor computation module 310 receives actual temperature sensor data from temperature sensors placed in the vicinity of a TEL 101₁ vent. In such an embodiment, the load profile generation module 311 determines how effective cycling various actuators in a TEL for a given temperature range is to reach a desired temperature. The component load profile generation module 311 also includes background data such as weather (e.g., cooler days may only require fan operation) or day of the week (e.g., weekends at stores may have greater foot traffic and constant air conditioning to a set temperature).

The communication module 312 processes communication exchanges with the DR server 106. The communication module 312 sends measurement data to the DR server 106 and processes commands for a component load profile to components in respective TELs 101_{N}. The demand communication module is configured to receive communications through wireless, cellular, wired LAN network connections or power line communication (PLC) from the DR server 106. In some embodiments, the communications with the DR server 106 are done through secure communication protocols or may require authentication into the DR server 106.

In other embodiments, the communication module 312 may include receiving real-time energy consumption data and indoor temperature data in addition to historical data. The real-time data is applied to adjust in the system 100, specific components and operating modes of TELs 101_{N} to model a response to meet the demand requirements received from the DR server 106.

In some embodiments where component load profiles are generated on the DR server, the communication module 312 communicates sensor and actuator data for the TELs 101_{N} with the DR server 106.

The actuator coordination module 314 includes instructions for communicating with and controlling individual components of the TELs 101_{N}. The actuator coordination module 314 converts data of desired operating temperature and mode from the DR server 106 for a calculated desired load trajectory into the requisite communication signal necessary to control a specific component of a TEL 101₁. For example, the energy gateway 103₁ may be coupled to one TEL 101₁ configured to receive commands wirelessly through IEEE 802.11(g) as well as another TEL 101₂ configured to receive commands through a wired LAN connection or power line communication (PLC). TEL 101₁ is controlled to operate the actuator for a fan only mode and TEL 101₂ is controlled to operate with both the fan and condenser on.

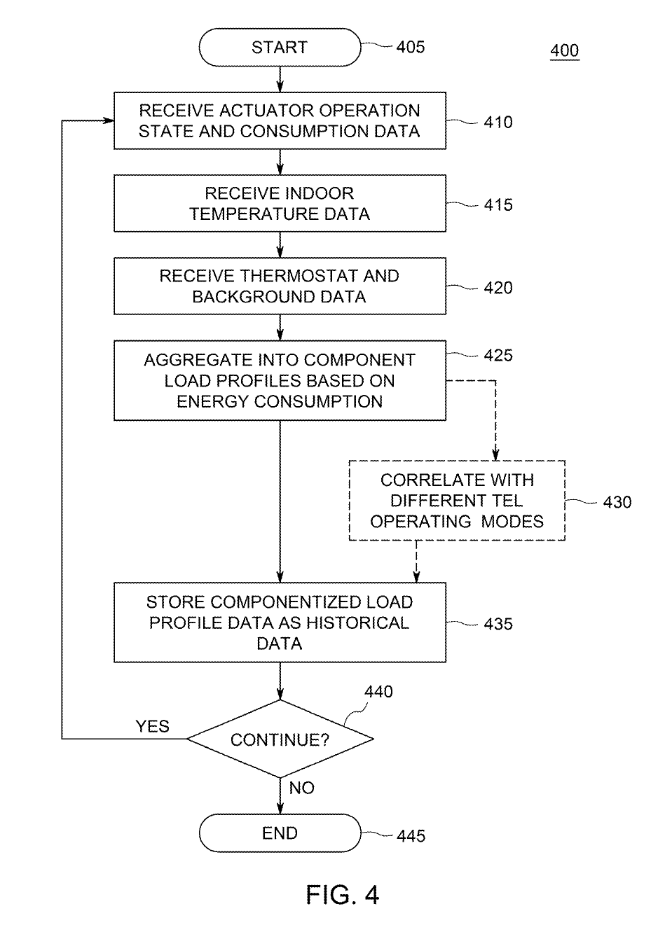

FIG. 4 is a flow diagram of an exemplary method 400 for generating profiles of individual componentized loads in accordance with an embodiment of the present invention. The method 400 is implemented by the DR server 106 and energy gateways 103_{N} and system 100 described above. Load profiles are initially built during an observational period spanning months prior to deployment in a demand response event. In addition, established load profiles may be continually updated over time.

The method 400 begins at step 405 and continues to step 410. At step 410, actuator operation data and energy consumption data is received. Operation data includes whether an actuator is active (e.g., in an ON state), the duration of the state, as well as operational details such as the speed of a fan.

At step 415, temperature data from component sensors is received. Temperature data sampled includes the thermostat settings, indoor ambient temperature, and outdoor temperature. Power consumption data includes kW, kilo-watt hour (kWh), instantaneous current, instantaneous voltage, and the like. The sampling rate of sensor data has a higher frequency than the duty-cycle of an exemplary TEL 101_{N}. For example, a rooftop AC unit cycles on/off every 15 minutes to maintain a constant indoor temperature. In such an example, to properly measure power and temperature data, sampling must be at a rate higher than once per 15 minutes such as once every 2, 4, 30 seconds or 5 minutes and the like.

Next, at step 420, background data is received. Background data includes public weather data, address, TEL unit information, time, date, geographic location, elevation and the like.

Next, at step 425 power consumption data for each measured component and operational data is associated and aggregated with the temperature data and other received data from steps 415 and 420. Data that is aggregated into a component load profile is based on power consumption for an observational period. By aggregating data over time, the component load profile includes load trajectories for each component of specific TELs 101_{N} to maintain a specific temperature during the operating environment as determined from the background data. Similarly, certain data may be flagged in a load profile for anomalous events rare events such as natural disasters and given less importance in a profile.

The component load profiles allow for a detailed fine granularity of observing and controlling loads. For example, a 1200 watt TEL 101₁ operating in a single-family unit during the heat of summer when the outdoor ambient temperature is 101 degrees may require 4 kWh to maintain a temperature at 68 degrees, but 2 kWh to maintain a temperature of 70 degrees for a day using just the fan. The same TEL 101₁ may require 1 kWh to maintain a temperature at 70 degrees when the outdoor ambient temperature is 80 degrees for a day. In some embodiments, the association of power consumption data and operational modes adjusts for user preferences that may include specific temperature ranges that must be maintained throughout the day or for a time of day.

Optionally, at step 430, component load profiles may be correlated to an operating mode for each of the TELs 101_{N}. Modal operation may be correlated and grouped by location to allow faster allocation of resources or adjustments of loads within the grid. For example, user accounts or TELs 101_{N} with efficient HVAC systems may be controlled to run in a fan only mode while older HVAC systems operate in a full mode operation. The net result is a reduction in power consumption for a specified new load trajectory with less temperature deviations in the buildings served by the HVAC systems.

At step 430, the component load profiles are stored in memory as historical data for assigned TELs 101_{N}. The method 400 proceeds to step 450 to determine whether to continue building and/or updating load profiles. If a determination is made to continue, the method 400 reverts to step 410. If however, a determination is made not to continue, the method 400 ends at step 445.

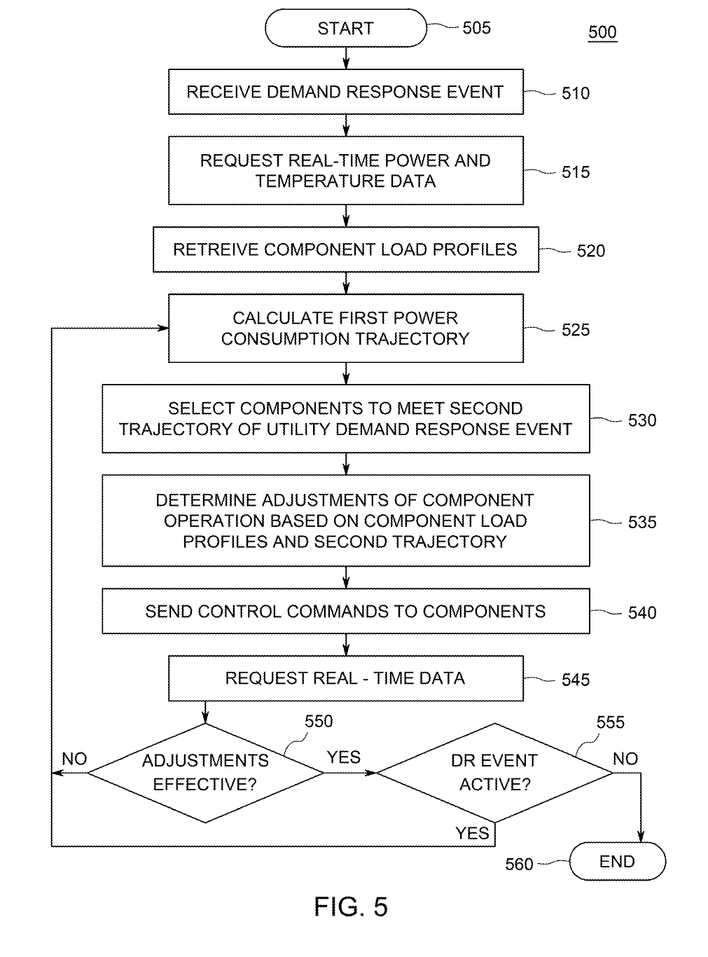

FIG. 5 is a flow diagram of an exemplary method 500 for demand response using the load profiles in accordance with an embodiment of the present invention. The method 500 is implemented by system 100, energy gateways 103_{N} and the controller 300 described in FIGS. 1 and 2 above.

The method 500 begins at step 505 and continues to step 510. At step 510, a demand response event is received from a utility or DR server 106. In some embodiments, a load trajectory is calculated to meet the requirements of the demand response event.

Next, at step 515, a request for real-time power consumption and temperature data is made to the components (e.g., indoor and outdoor temperature sensors 203 and 205 and power consumption meter 235) of the TELs 101_{N}.

Next, at step 520, select component load profiles with historical data is retrieved from the database 316 for respective TELs 101_{N}. The selected component load profiles are those corresponding individual components of TELs 101_{N} of a region that is receiving the demand response event signal.

Then at step 525, the method 500 calculates a first trajectory of the current power consumption by active components of the TELs 101_{N}. Calculations include comparing historical data in the component load profiles to that of the requirements from the desired demand event. For example, historical data associates the amount of power consumed to operate in a specific temperature range. Thus, the amount of power drawn by a specific TEL 101₁ and components may be predicted if operated at a specific temperature using recorded operating modes. The prediction is further defined based on background data in the component load profiles discussed above. Calculations also include summing multiple load profile waveforms corresponding to power usage.

In some embodiments, parameters for determining load trajectory are calculated based on thermal capacitance and resistance of specific components in the TELs 101_{N}. Thermal characteristics of each TEL 101_{N} may be determined by Equation 1:

a=e^{-h/(CR)} (1)

In the above Equation 1, parameter “a” represents the thermal characteristic of a TEL 101 with operating components. Parameters “C” and “R” are respectively the thermal capacitance and resistance of the TEL 101_{N} for specifically energized components (e.g., condenser fan 207) and “h” is a time step.

The transition or evolution of the indoor temperature in the next time step is a function of current indoor temperature, ambient outdoor temperature, and temperature gain provided in Equations 2 and 3:

T_{indoor,t+1}=aT_{indoor,t}+(1−a)(T_{outdoor}−uT_{gain})+ε (2)

T_{gain}=RPᵣₐₜₑ (3)

In Equations 2 and 3, T_{gain} is always a non-negative number, and ε is random temperature noise. The parameter “u” is either 0 or 1 that is representative of either an OFF state or ON state of the TEL 101_{N}. If T_{gain} is positive then the TEL 101_{N} is operating as a cooling unit and therefore driving the indoor temperature down when it is in the ON state (i.e. u=1). Similarly, T_{gain} is negative when the TEL is operating as a heating unit.

Since the system 100 does not know C, R, and ε a priori, these values must be “learned” over time (i.e., stored and calculated measurements accumulated over a time period). By collecting historic temperature and power data for each component, and performing semi-parametric regression on T_{indoor}, T_{outdoor}, and Pᵣₐₜₑ, the value of C, R, and ε may be estimated. Once sufficient data is observed a specified time period (e.g., day, week, month, season, year, and the like) has been collected and analyzed, a model for resolving a predictive control problem may be established for determining load trajectories and load profiles. In some embodiments, the values of the parameters may be adjusted as the values are subject to the uncertainty tolerance of the grid operator. The model for the predictive control is represented by xₜ in Equation 4:

xₜ₊₁=Cxₜ+Duₜ (4)

In the aforementioned Equation 4, the value of parameter xₜ represents a vector temperature, and power states for all TELs 101_{N}. A parameter uₜ is a vector value of control states composed on 0's (OFF state) and 1's (ON state) for each component of the TELs 101_{N}. For example, x=[28 29 24 27] represents in Celsius, four TELs with the individual temperature states of 28° C., 29° C., 24° C., and 27° C. The estimated power states are a function of the of the “u” vector, (e.g., if u=[0 0 1 0] then all but one of four components of a TEL is turned OFF).

The parameter “C” is a matrix derived from the temperature dynamics described in the above Equations 1-4. The parameter “B” is a matrix of representing the influence of the respective TEL control states in the system 100 (e.g., all TELs 101_{N} coupled to the DR server 106). The parameter xₜ₊₁ represents the predicted states of each of the TELs 101_{N}. In general, uₜ is aleatoric and substantially determined by the individual preferences of the TEL users (e.g., home owners, building tenants, and the like). However, when a DR event signal is dispatched from the DR server 106 to the energy gateways 103_{N} and TELs 101_{N}, the values of “uₜ” are selected as to control the sum of all values of Pᵣₐₜₑ in Equation 3 for all TELs 101_{N} within the system 100. The selections of the “u” values are based on a desired aggregate power consumption level of the grid operator communicated to the DR server 106. The load trajectory is thus determined so as operative to establish the desired aggregate power consumption level provided by the grid operator or utility provider (e.g., utility servers 108_{N}).

At step 530, component load profiles are selected that meet requirements for the second trajectory (a new load trajectory) that corresponds to the utility demand event received from the DR server 106.

At step 535, adjustments are calculated for each selected component based on the component load profiles and the second trajectory. By adjusting thermostat temperature, and scheduling the timing of cycling between ON states and OFF states of individual components, a new load trajectory is generated for TELs 101_{N}. The cumulative profile of all components and TELs 101_{N} results in a trajectory is a balanced load correlating to the desired demand event.

At step 540, the method 500 sends the corresponding control commands and temperature adjustments to the actuators of components in the TELs 101_{N} that are correlated to previous historical data energy consumption loads. For example, a previous load profile for a TEL 101₁ may show a steady-state operation of 0.8 kW for a temperature of 78 degrees. Continuing the example, a previous load profile for a TEL 101₂ may show a steady-state operation of 0.2 kW for a temperature of 75 degrees. The net operation of the TELs 101₁ and 101₂ would meet a new trajectory requirement of 1 kW.

Next at step 545, the method requests real-time power consumption and temperature data. This second sampling of data is used to determine the effectiveness of the newly implemented second trajectory in step 540.

At step 550, the method 500 determines whether the actuator adjustments to the components of the TELs 101_{N} was effective in meeting the demand response event requirement. In some embodiments, meeting the requirement may have a pre-determined acceptable error tolerance (e.g., +/−2%). Additional embodiments include determining if the adjustment is effective in maintaining a desired temperature in conjunction with meeting power consumption requirements. In either embodiment, if it is determined the adjustment is insufficient, the method 500 reverts back to step 525. If however, the adjustment is sufficient, the method 500 continues to step 550.

At step 555, the method 500 determines whether the demand response event is still active. If determined to be still active, the method 500 reverts back to step 525. In most instances, the events are temporary measurements taken by power utilities to prevent blackouts. Once an event is signaled as over or the event signal is no longer received from the DR server 106, the method 500 determines the event is not active and the method 500 ends at step 555.

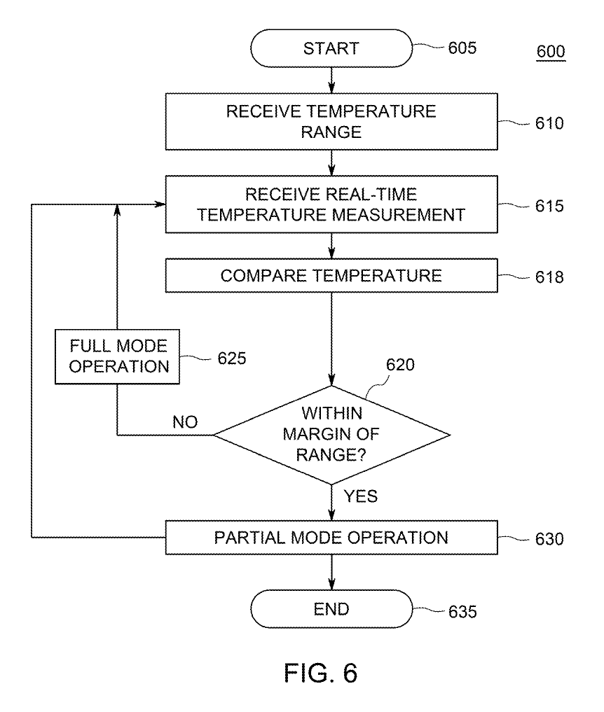

FIG. 6 is a flow diagram of an exemplary method 600 for reduced operation of thermostatic electric loads in accordance with an embodiment of the present invention. In some embodiments, the reduced operational modes are implemented using historical data in component load profiles discussed above.

The method 600 begins at step 605 and continues to step 610. At step 610, an acceptable operating temperature range is received. The range may be received from a user preference set on premises or from commands from the DR server 106 at a remote location.

Next at step 615, real-time temperature data is sampled from temperature sensors. The temperature sensors may be indoor, outdoor, or the temperature sensors 203 and 205.

At step 618, the real-time measurement is compared to the temperature range.

At step 620, the real-time measurement is determined to be within the range received in step 610. In some embodiments, a pre-determined margin (e.g., +/−1 degree) is applied at step 620. For example in a temperature range of 70 to 75 degrees Fahrenheit, the method 600 determines being within range as 71 to 74 degrees (e.g., 1 degree margin). If the method 600 determines a building temperature is out of range or beyond the margin, the method 600 continues to step 625 and operates at full mode and returns to step 615. If however, the method 600 determines, the real-time measurement is within range, the method 600 proceeds to step 630.

At step 630, the individual components of a TEL are operated such that the TEL is in a partial operation mode. The partial operation mode energizes a portion of the TEL such that select components (e.g., fan) are operating. The partial operation mode allows distribution of any residual heated or cool air within the HVAC system at a reduced power. The method 600 then ends at step 635.

The foregoing description of embodiments of the invention comprises a number of elements, devices, circuits and/or assemblies that perform various functions as described. These elements, devices, circuits, and/or assemblies are exemplary implementations of means for performing their respectively described functions.

While the foregoing is directed to embodiments of the present invention, other and further embodiments of the invention may be devised without departing from the basic scope thereof, and the scope thereof is defined by the claims that follow.

1. A method for controlling thermostatic electric loads (TELs), the method comprising:
transmitting, from a demand response server, a demand response event signal to a plurality of energy gateways, the demand response corresponding to an efficiency requirement of a coupled grid;
receiving, from the plurality of energy gateways, a load profile for each of a plurality of thermostatic electric loads (TELs) coupled to each of the plurality of energy gateways; and
transmitting one or more control signals to the energy gateways to control operation of the plurality of TELs to yield an efficiency corresponding to the efficiency requirement.

2. The method of claim 1, further comprising:
interfacing with external systems to receive efficiency information related to improving reliability and/or efficiency of the grid.

3. The method of claim 2, wherein the external systems include at least a price server, an energy trading platform for retail electricity markets and an energy trading platform for wholesale electricity markets.

4. The method of claim 2, wherein the external systems include billing and account servers of electricity provides serving customers with ownership of energy gateways in communication with the demand response server.

5. The method of claim 1, wherein the demand response server receives sensor data from the plurality of energy gateways, and further:
generates component load profiles for each component coupled to each of the plurality of energy gateways.

6. The method of claim 5, wherein the sensor data comprises at least one of indoor ambient temperature data, outdoor ambient temperature data, thermostat settings and power consumption data correlated with resultant indoor temperature.

7. The method of claim 6, wherein the power consumption data contains information regarding period of time for when a component of a TEL is in an ON state, correlated with a resultant indoor temperature.

8. The method of claim 1, further comprising:
aggregating global background information available publicly; and
correlating the global background information with data associated with each of the plurality of TELs.

9. The method of claim 8, further comprising:
adjusting measurements relating to the plurality of TELs with respect to user preferences.

10. The method of claim 1, further comprising:
calculating a response and load trajectory, for each of the plurality of TELs, to the demand response event signal.

11. The method of claim 10, wherein calculating the response further comprises determining optical temperature settings for each of the plurality of TELs based on their corresponding load profile to achieve a target power demand based on the demand response event signal.

12. The method of claim 10, wherein calculating the response further comprises:
determining adjustments of attributes of components of each of the plurality of TELs necessary to meet the load trajectory based on a pre-determined load profile.

13. A method for selective componentized thermostatic electric loads (TELs) comprising:
receiving a demand response event signal at an energy gateway from a demand response server;
receiving real-time measurements of a temperature value and a power consumption value of a plurality of components in each of a plurality of TELs corresponding to a temperature setting;
retrieving historical data from pre-determined component load profiles for each component of the plurality of components;
selecting components for control based on the historical data from the component load profiles;
comparing selected component load profiles and real-time measurements to determine a first consumption trajectory; and
coordinating control of components of at least two TELs of the plurality of TELs to generate a second consumption trajectory corresponding to the demand response event signal.

14. The method of claim 13, wherein the demand response event signal indicates that power consumption must be modified in order to achieve a particular efficiency.

15. The method of claim 13, further comprising:
interfacing with external systems to receive efficiency information related to improving reliability and/or efficiency of the grid.

16. The method of claim 15, wherein the external systems include at least a price server, an energy trading platform for retail electricity markets and an energy trading platform for wholesale electricity markets.

17. The method of claim 15, wherein the external systems include billing and account servers of electricity provides serving customers with ownership of energy gateways in communication with the demand response server.

18. An apparatus for controlling thermostatic electric loads (TELs), the apparatus comprising:
a demand response calculation module that transmits, from a demand response server, a demand response to a plurality of energy gateways, the demand response corresponding to an efficiency requirement of a coupled grid;
a component processing module that receives, from the plurality of energy gateways, a load profile for each of a plurality of thermostatic electric loads (TELs) coupled to each of the plurality of energy gateways; and
a load assignment module that transmits one or more control signals to the energy gateways to control operation of the plurality of TELs to yield an efficiency corresponding to the efficiency requirement.

19. The apparatus of claim 18, wherein the component processing module interfaces with external systems to receive efficiency information related to improving reliability and/or efficiency of the grid.

20. The apparatus of claim 19, wherein the external systems include at least a price server, an energy trading platform for retail electricity markets and an energy trading platform for wholesale electricity markets.
